(19) United States
(12) Patent Application Publication
(10) Pub. No.: US 2004/0039094 A1
(43) Pub. Date: Feb. 26, 2004

(54) Coating compositions

(76) Inventor: Alan Taylor, Cambridge (GB)

Correspondence Address: Dickstein Shapiro Morin & Oshinsky, 1177 Avenue of the Americas, 41st Floor, New York, NY, 10036-2714, US

(21) Appl. No.: 10/380,329

(22) PCT Filed: Sep. 21, 2001
(86) PCT No.: PCT/GB01/04233

(30) Foreign Application Priority Data
Mar. 22, 2001 (GB) 0107233.9
Apr. 12, 2001 (GB) 0109391.2

(51) Int. Cl. B05D 3/02; C08K 5/24

(52) U.S. Cl. 524/261; 427/385.5

(57) ABSTRACT

A coating composition comprises an inorganic phase homogeneously mixed with an organic phase, the inorganic phase being obtainable by hydrolysis of first and second hydrolysable inorganic monomer precursors, the first hydrolysable inorganic monomer precursors (A1) being different to the second hydrolysable monomer precursors (A2) and having at least two hydrolysable ligands, and the second hydrolysable inorganic monomer precursors having at least one non-hydrolysable ligand, the organic phase comprising polymerisable organci organic species, characterized in that the molar ratio, R (A), of first hydrolysable inorganic monomer precursors (A1): total hydrolysable inorganic monomer precursors (A1 & A2) is in the range 0.4 t to 0.99.

### FIELD OF THE INVENTION

The present invention relates to coating compositions for application to a variety of different substrates, so as to impart to those substrates resistance to mechanical and chemical damage, while at the same time maintaining excellent optical properties.

### BACKGROUND OF THE INVENTION

Polymer-based materials are routinely used as alternatives to glass in many situations where the weight, tendency to shatter, or expense of glass contraindicates its use. In turn, polymeric materials such as acrylic and polycarbonates have inherent drawbacks, particularly with regard to poor abrasion-resistance, but also with regard to poor resistance to degradation by UV light, and poor corrosion resistance on exposure to organic solvents.

In order to address these problems, protective coatings have been applied on to polymeric materials. Silica-based materials have been widely used for this purpose, typically made by colloidal sol-gel techniques, in which silica particles coalesce and ultimately gel to form an extensive silica network. However, these materials offer only limited protection. Furthermore, due to the inert nature of these materials, and in particular their low levels of cross-linking, there is little scope for further improvement in either their performance or their versatility.

Coatings provided by way of polymeric sol-gel techniques have higher levels of cross-linking, and therefore significantly better mechanical and chemical resistance than the conventional particulate-based materials. Typically, in polymeric sol-gel techniques precursor molecules, such as alkoxides, are hydrolysed in a mixture of water and solvent, and proceed to undergo a transition from a sol to a gel state by polycondensation. Unfortunately, however, removal of the solvent after gelation, by forced drying or by natural evaporation, introduces stresses within the gel structure, which at coating thicknesses greater than around 1.5 μm tends to result in cracking, and a loss in performance. One approach to coping with this restriction is to apply multiple thin coatings, usually with a practical limit of 20 to 30 coats. However, this is cumbersome, and increases production costs, and also results in relatively rigid coatings.

Where coatings thicker than 1.5 μm are needed composite inorganic/organic materials have been employed. These materials are typically prepared by incorporating a polymerisable organic component into a colloidal sol-gel system, and are generically termed ORMOCERs® (Organically-Modified Ceramics). ORMOCERs can be thought of as comprising a network of silica (or other metal oxide) particles within an organic polymer network. There is little interpenetration between the two networks.

While materials of this type form relatively hard, abrasion-resistant coatings, at oxide loadings of around 25% by weight and above, where optimum hardness is achieved, transparency problems have been encountered. Furthermore, until relatively recently most of these materials have tended to cure at temperatures of around 200° C., or higher, rendering them unsuitable for application to substrates having low softening points, e.g. thermoplastic substrates having softening points of 150° C. or lower.

The development of low temperature coating materials which do not suffer from the draw-backs of the hitherto used silica-based materials is, therefore, very much in demand.

U.S. Pat. No. 4,921,881 describes scratch-resistant coatings for organic glasses, the coatings consisting of (A) 82 to 64 weight % of a co-condensate prepared from 90 to 65 weight % vinyl trimethoxysilane or vinyl triethoxysilane or mixture thereof and 10 to 35 weight % tetramethoxysilane or tetraethoxysilane or a mixture thereof; (B) 9 to 27 weight % of a reactive diluent comprising at least two vinyl, acrylic or methacrylic groups per molecule; and (C) 0 to 9 weight % of a photoinitiator.

EP-A-0851009 discloses an anti-fouling coating composition comprising (A) a silica-dispersed oligomer solution of an organosilane obtained by partial hydrolysis of an hydrolysable organosilane, at least 50 mol % of which comprises an hydrocarbon group having 1 to 8 carbon atoms; (B) an acrylic copolymer; (C) a linear polysiloxane dial; (D) a polyorganosiloxane containing a silanol group; and (E) a curing catalyst. A preferred coating composition comprises 20 to 35 weight % (A), 35 to 55 weight % (B), 5 to 25 weight % (C), 5 to 25 weight % (D) and 0.5 to 3 weight (E).

U.S. Pat. No. 5,470,910 discloses composite materials for use as optical elements, but which are claimed also to be of use as coatings. The composite materials are formed by reacting mixing together a sol containing inorganic nanoscale particles and a compound which can be polymerised into an organic, inorganic or organic/inorganic network.

In our earlier co-pending application WO-A-0125343, we described novel coating compositions fabricated by polymeric sol-gel technology. Essentially the coating compositions described in WO-A-01265343, and those of the present invention, comprise two structural components: an inorganic phase and an organic phase. These two phases form interpenetrating networks on the nanometer scale, and so are indistinguishable using electromagnetic radiation with visible wavelengths.

In more detail, the inorganic phase is formed by hydrolysis and subsequent polycondensation of at least two different types of hydrolysable inorganic monomer precursors to form an inorganic sol. The inorganic sol is homogeneously mixed with a polymerisable organic species, which on polymerisation gives rise to the organic phase, It is essential that polymerisation of the organic species is initiated prior to conversion of the inorganic sol into its final gel form.

The properties of the final coating depend upon the nature and amounts of the constituent parts of the coating composition.

### SUMMARY OF THE INVENTION

It has now been found that the coating compositions can be tailored according to the nature of the substrate to be coated and/or the desired application of the coating, by varying the amount of the inorganic phase and, more importantly, the relative amounts of the different components making up the inorganic phase.

Thus, according to the present invention, a spectrum of different coating compositions is provided which may be applied to a variety of different substrates, as defined in claim 1, and as will be described in more detail below.

### DETAILED DESCRIPTION OF THE INVENTION

The coating compositions of the present invention are of the same general type as those described in WO-A-0125343.

The coating compositions comprise an homogeneous mixture of the following components:

(A) An inorganic oxide polycondensate formed by hydrolysis and polycondensation of at least two different compounds of the general formula:

MR¹ₐR²_{b}(OR³)_{c} [1]

where M typically represents an element selected from the group consisting of Si, Ti, Zr, Fe, Cu, Sn, B, Al, Ge, Ce, Ta and W preferably the group consisting of Si, Ti, Al and Zr, and most preferably Si; R¹ and R² are typically independently selected from hydrocarbon radicals having 1 to 10 carbon atoms, and which may contain an ether linkage or ester linkage; R³ is typically a hydrogen atom or a hydrocarbon radical having 1 to 10 carbon atoms; and a and b are independently selected from zero and integers, and c is an integer equal to (x-a-b), where x is the valency of the element M.

(B) A polymerisable organic species such as those which, upon polymerisation, form thermoplastic polymers or thermosetting polymers.

(C) If required, a polymerisation initiator to initiate polymerisation of the polymerisable organic species.

(D) Optionally, non-structural, functional additives, such as UV-absorbers, viscosity modifiers, dyes and surfactants.

In the following, components (A), (B) and (C) will be referred to as the structural components of the coating composition, and component (D) as the non-structural, functional component.

Preferably, the structural components (A) and (B) constitute at least 85 weight % of the total coating composition. As is clear from the above, components (C) and (D) are merely optional. Whether a polymerisation initiator (C) will be required will depend upon the nature of the polymerisable organic species and/or the nature of component (A). Whether it is desirable, or necessary, to include a non-structural, functional, component (D) in the coating composition will depend upon the properties required of the coating composition and/or its field of application.

As mentioned above, the inorganic oxide polycondensate is formed by hydrolysis and polycondensation of at least two different compounds of general formula [1]. In the following, the two different types of compound [1] will be referred to as component A1 and component A2.

Component A1 is the primary inorganic network-forming species, and is preferably defined by the general formula [1]in which a=b=0, such that component A1 is represented by the general formula:

M(OR³)_{c} [2]

In other words, component A1 contains only hydrolysable ligand bonded to inorganic element M.

Examples of these compounds include inorganic alkoxides such as:

i) silicon tetra-alkoxides such as tetramethoxysilane, tetraethoxysilane, tetraisopropoxysilane, and tetrabutoxysilane;

ii) titanium tetra-alkoxides such as titanium tetra-n-propoxide, titanium tetra-iso-propoxide and titanium tetrabutoxide;

iii) aluminium tetra-alkoxides such as aluminium tri-secbutoxide, aluminium tri-n-butoxide aluminium tri-isopropoxide;

iv) zirconium tetra-alkoxides such as zirconium-tetra-n-propoxide, zirconium tetra-iso-propoxide and zirconium tetrabutoxide; and

v) metal alkoxides such as copper dimethoxide, barium diethoxide, boron trimethoxide, gallium triethoxide, germanium tetraethoxide, lead tetrabutoxide, tantalum penta-n-propoxide and tungsten hexaethoxide.

If desired, a number of different types component A1 may be included in the coating composition.

Component A2 may be referred to as the secondary inorganic network-forming species, and is a compound having the general formula [1] but where either or both of a and b have a non-zero value. That is, these compounds possess at least one non-hydrolysable ligand. These compounds can be described as being bi-functional. One functionality is possessed by the ligand(s) which can be hydrolysed and then participates in the building of an oxide-based inorganic network through a polycondensation route. The other functionality is possessed by the non-hydrolysable ligand(s), which is converted through polymerisation into an organic network. By virtue of this bi-functionality the overall inorganic network may be considered to have an inorganic-organic hybrid status.

As mentioned above, the particularly preferred compounds represented by the general formula [1] are those in which M represents Si. Examples of such compounds for use as component A2 include:

i) alkyl) alkoxysilanes such as trimethoxysilane, tri-ethoxysilane, tri-n-propoxysilane, dimethoxysilane, diethoxysilane, di-iso-propoxysilane, monomethoxysilane, monoethoxysilane, monobutoxysilane, methyldimethoxysilane, ethyldiethoxysilane, dimethylmethoxysilane, di-iso-propylisopropoxysilane, methyltrimethoxysilane, ethyltriethloxysilane, n-propyltri-n-propoxysilane, butyltributoxysilane, dimethyldimethoxysilane, diethyldiethoxysilane, di-iso-propyl-di-iso-propoxysilane, dibutyldibutoxysilane, tri-methylmethoxysilane, triethylethoxysilane, tri-n-propyl-n-propoxysilane, tributylbutoxysilane, phenyltrimethoxysilane diphenyldiethoxysilane and triphenylmethoxysilane;

ii) (alkyl)alkoxysilanes having an isocyanato group such as 3-isocyanatopropyltrimethoxysilane, 3-isocyanatopropyltriethoxysilane, 3-isocyanatopropylmethyldimethoxysilane, 3-isocyanatopropylethyldiethoxysilane, 3-isocyanatopropyldimethyl-iso-propoxysilane, 3-isocyanatopropyldiethyl-ethoxysilane, 2-isocyanatoethyldiethylbutoxysilane, di(3-isocyanatopropyl)diethoxysilane, di(3-isocyanatopropyl)-methylethoxysilane, and ethoxytriisocyanatosilane;

iii) (alkyl)alkoxysilanes having an epoxy group such as 3-glycidoxypropyltrimethoxysilane, 3-glycidoxypropyltriethoxysilane, 3-glycidoxypropylmethyldimethoxysilane, 3-glycidoxypropylmethydiethoxysilane, 3-glycidoxypropyldimethyl ethoxysilane, 2-(3,4-epoxycyclohexyl)ethyltrimethoxysilane, and 3,4-epoxybutyltrimethoxysilane;

iv) (alkyl)alkoxysilanes having a carboxyl group such as carboxymethyltriethoxysilane and carboxymethylethyldiethoxysilane;

v) alkoxysilanes having an acid anhydride group such as 3-(triethoxysilyl)-2-methpropylsuccinic anhydride;

vi) alkoxysilanes having an acid halide group such as 2-(4-chlorosulphonylphenyl)ethyltriethoxysilane;

vii) (alkyl)alkoxysilanes having an amino group such as N-2-(aminoethyl)-3-aminopropyltriethoxysilane, N-2-(aminoethyl)-3-aminopropylmethyldimethoxysilane, and N-phenyl-3-aminopropyltrimethoxysilane;

(x) (alkyl)alkoxysilanes having a thiol group such as 3-mercaptopropyl-trimethoxy-silane, 3-mercaptopropyltriethoxysilane, 2-mercaptoethyltriethoxysilane, and 3-mercaptopropylmethyldimenthoxysilane;

ix) (alkyl)alkoxysilanes having a vinyl group such as vinyltrimethoxysilane, vinyltriethoxysilane, and vinylmethyldiethoxysilane;

x) (alkyl)alkoxysilanes having an acrylate or methacrylate group such as 3-methacryloxypropyltrimethoxysilane, 3-methacryloxyproplytriethoxysilane, 3-methacryloxypropylmethyldimethyl-silane and 3-acryloxypropyltriethoxysilane;

xi) (alkyl)alkoxysilanes having a halogen atom such as triethoxyfluorosilane, 3-chloropropyltrimethoxysilane, 3-bromoalkylalkoxysilane, and 2-chloroethylmethyldimethoxysilane;

xii) (alkyl)alkoxysilanes having an halogenated alkyl ligand such as (3,3,3-trifluoropropyl)trimethoxysilane and 1H,1H,2H,2H-perfluorodecyltriethoxysilane; and

xiii)-(alkyl)alkoxysilanes employing an alkoxy group as a functional group such as isopropyltri-isopropoxysilane and tri-isopropylisopropoxysilane.

The preferred compounds for use as component A2 are those having at least one relatively bulky non-hydrolysable ligand. By relatively bulky typically we mean that the ligand provides greater steric hindrance than a single vinyl group. Particularly preferred components for use as component A2 are (alkyl)alkoxysilanes having a group selected from epoxy-groups, amino and methacryl groups, i.e. those of sub-classes iii), viii) and x) mentioned above. Particularly preferred compounds for use as component A2 are 3-glycidoxypropylimethoxysilane (GPTS), N-phenyl-3-aminopropyltrimethoxysilane (PAPMS), and 3-methacryloxypropyltrimethoxysiliane (MPTMA).

If desired, a number of different types of component A2 may be included in the coating composition.

The most preferred combinations of components A1 and A2 comprise a silicon tetra-alkoxide, particularly tetramethoxy or tetraethoxysilane, and any of GPTS, PAPMS and MPTMA.

Components A1 and A2 may be hydrolysed through the addition of water, or the generation of water in situ. It is generally preferred to use a mineral acid to initiate hydrolysis of components A1 and A2. It is also generally preferred to initiate hydrolysis of components A1 and A2 separately from one another, and then to mix the resulting mixed sol with the polymerisable organic species.

The nature of the polymerisable organic species (B) is selected according to the properties required in the final coating. Typically, the polymerisable organic species will be selected to provide strength and abrasion-resistance and, where desired, transparency. It is essential, however, that the polymerisable organic species be selected such that on drying of the coating, including removal of any volatile components, and subsequent curing of the coating, substantially no organic material is lost from the coating composition, as this may reduce the compatibility of the inorganic and organic phases, ultimately making the composition difficult or impossible to coat, and/or resulting in poor properties, e.g. cracking.

Examples of suitable polymerisable organic species include carbonates, esters such as terephthalates, urethanes, di-pentaerythritol acrylates, and monomers or oligomers which contain at least one reactive acrylate or methacrylate, ie. (meth)acrylate, ligand such as urethane (meth)acrylates, epoxy (meth)acrylates, polyester (meth)acrylates, polyether (meth)acrylates, amino-modified polyether (meth)acrylates, (meth)acrylic (meth)acrylates, (meth)acrylates of urethane precursors and mixtures thereof. The (meth)acrylates of urethane precursors, such as isocyanates, diisocyanates and polyols, and urethane (meth)acrylates are particularly preferred, and aliphatic (meth)acrylates are preferred to aromatic (meth)acrylates. Organometallic monomers may also be used, but in this case they will not contain hydrolysable bonds.

Preferably, the polymerisable organic species can be polymerised at relatively low temperature, e.g. lower than 150° C., after addition of a suitable initiator, or by irradiation, e.g. with UV or IR light, or bombardment with X-rays or electron beams, so as to be applicable as coatings for thermoplastic materials or thermosetting materials having low melting points. Polymerisable organic species which give rise to polymers which have good resistance to organic solvents are also preferred. In the case of the carbonates, therefore, aliphatic carbonates as opposed to aromatic carbonates are preferred.

Suitable polymerisation initiators (C) are those which can induce, thermally and/or photochemically, the polymerisation and cross-linking of the polymerisable organic species. The polymerisation initiators may also act on the non-hydrolysable ligand(s) of component A2.

Examples of suitable initiators are commercially available photoinitiators such as Irgacure® 184 (1-hydxoxycyclohexylphenylketone), Irgacure® 500 (50% 1-hydroxycyclohexylphenylketone: 50% benzophenone) and other photo-initiators of the Irgacure® type, such as Irgacure® 819 (bis-acyl phosphine oxide), that are available from Ciba Specialty Chemicals Company; and Darocur® 1173, also available from Ciba Specialty Chemicals Company. Other compounds that can be used as photo-initiators include benzophenone, 2-chlorothioxanthone, 2-methylthixoanthone, 2-isopropyl-thixoanthone, benzoin, 4,4′-dimethoxybenzoin, benzoin ethyl ether, benzoin, benzyl dimethyl ketal, 1,1,1-trichloro-acetophenone, and diethoxyacetophenone.

Suitable thermal initiators include organic peroxides such as diacylperoxides, peroxydicarbonates, alkyl peresters, dialkyl peroxides, perketals, ketone peroxides and alkyl hydroperoxides. Specific examples of such thermal initiators are dibenzoyl peroxide and azobisisobutyronitrile.

Depending upon the nature of the polymerisable organic species and component A2 it may be desirable to use a mixture of different polymerisation initiators, or it may be desirable to select the nature of the polymerisable organic species and component A2 so as to allow the use of a single, common, polymerisation initiator.

As mentioned above the coating composition may also include functional additives, which are not chemically incorporated into the inorganic and organic networks yielded from components (A) and (B). Suitable additives include surfactants such as the commercially available Fluorad® FC430 from 3M; UV-absorbers and light stabilisers such as the Tinuvin® products from Ciba Speciality Chemicals Company; dyes; viscosity modifiers; corrosion inhibitors; fungicides; and algicides.

For certain applications, for instance where the coating will be exposed to sunlight or other UV light, it include a UV absorber, other than any UV-absorbing photoinitiator incorporated for the purpose of initiating polymerisation. In this case, it is preferred that the UV absorber have a different TV absorption fingerprint to that of any UV photoinitiator included in the composition, so that it does not detract from polymerisation of the coating composition. The UV absorber may be included in the final coating composition, but preferably it is included in the inorganic sol or with one of the hydrolysable inorganic monomer precursors prior to formation of the mixed sol. Typical amounts of UV absorber for inclusion in the coating composition lie in the range 1 to 15 weight %, preferably 5 to 15 weight %, more preferably 10 to 15 weight %.

The inorganic phase of the final coating is developed from components A1 and A2, and the organic phase is developed from components (B) and (C). It is believed that some chemical linkage may occur between the inorganic and organic phases, but this is not essential to the success of the coating. The inorganic content of the final coating can be calculated from the relative proportions of components (A), (B) and (C), when these are assumed to have undergone, nominally, complete cross-linking, or curing. This is what is intended by reference in the present Application to proportions of components in the coating composition “when cured”. Although it is recognized that full cross-linking, or curing, of these components may not be achieved in practice.

A wide range of compositions may be envisaged for the production of coatings comprising different proportions of inorganic and organic phases. For instance, the coating compositions may comprise amounts of inorganic monomer precursors and polymerisable organic species such that the final, cured, coating comprises 1% to 99% by weight of an organic phase and 99% to 1% by weight of an inorganic phase, based upon the total weight of the inorganic and organic phases, and assuming full cross-linking of all components in the final coating. However, as general rule, the coatings offering the best protection from mechanical and/or chemical damage are those in which the ceramic-like, or inorganic, properties have been maximised. To this end, it is preferred that the coating composition be formulated to achieve in the final coating 50 to 99 weight %, preferably 75 to 99 weight %, and most preferably 90 to 99 weight %, of an inorganic phase based upon the total weight of the inorganic and organic phases, again assuming full cross-linking, even though this may not ultimatey be achieved in practice. As mentioned above, the inorganic and organic phases together preferably constitute at least 85 weight % of the coating composition, and thereby the final coating.

The minimum requirement for producing a practical, protective coating on a specific substrate is that the coating remains coherent during fabrication. If the coating has a significant property mismatch with the substrate residual stresses are generated. If these residual stresses cannot be relieved or are beyond the yield strength of the coating, cracks will be generated and the coating will fail. The coefficient of thermal expansion (CTE) is a primary material property of the coating that needs to be matched to the substrate, in order not to generate significant tensile stresses in the coating. Deposition of a coating with a greater CTE than that of the substrate yields a coating that is placed in compression, and which can therefore survive the fabrication procedure.

The production of a coating with the optimum scratch resistance requires a composition that yields a coating with a CTE of at least equal to that of the substrate, whilst having a maximum ceramic likeness. As a generality, the ceramic nature of the coating increases, and the CTE decreases, as the amount of the inorganic phase, and the relative amount of Component A1 as compared to Component A2, increases. The relative amounts of Components A1 and A2 can be described as a molar ratio, R(A), where:

$$R ( A ) = \frac{m A1}{( m A1 + m A2 )}$$

where mA1 is the total number of moles of component A1 and mA2 is the total number of moles of component A2. Where different types of components A1 and/or A2 are included in the coating compositions, mA1 and mA2 represent the total number of moles of each of those components in combination.

Generally, it has been found that useful coating compositions have a molar ratio R(A) in the range 0.40 to 0.99, for instance, 0.4 to 0.95, 0.4 to 0.9, 0.4 to 0.85, or 0.4 to 0.8. Although, in certain cases, lower ratios than 0.4 may be suitable. Preferably, however, the ratio R(A) lies in the range 0.45 to 0.99 or 0.5 to 0.99, for instance 0.5 to 0.95. More preferably the ratio R(A) lies in the range 0.5 to 0.9, and most preferably R(A) lies in the range 0.5 to 0.85 or 0.5 to 0.8. However, the optimum R(A) value will usually depend upon the substrate on to which the coating is to be deposited, and in particular its CTE, and/or the final properties required of the coating.

One way of characterising the different coating compositions is in the context of their being suitable for coating onto substrates of different CTE. It is envisaged that according to the present invention the coating compositions may be formulated for the protection of a wide variety of substrates, for instance selected from different plastics, metals, ceramic materials, and natural materials, such as leather and wood, and synthetic substitutes therefor. The coating compositions of the invention may also be successfully applied to substrates which have already been coated by another material for protective or decorative purposes. For instance, the substrate may beta painted or varnished substrate.

As a generality, metals tend to have relatively low CTE values, with aluminum having one of the highest CTEs at approximately 24×10⁻⁶/° C. Plastics substrates may have a wide range of different CTEs, for instance from about 10×10⁻⁶/° C. to over 100×10⁻⁶/° C.

In the following, and consistent with the remainder of this Application, the quoted inorganic phase contents are given as a proportion of the structural components of the coating composition, when said components are assumed to have undergone full cross-linking, i.e. in the final, cured, coating.

Generally, for substrates having a CTE of up to 25×10⁻⁶/° C., coatings with any of the above R(A) values may be used. However, with coatings having a high inorganic phase content, for instance at leant 95 weight % of the structural components, it may be desirable to use a R(A) value of at most 0.98. Furthermore, for application to substrates of slightly higher CTE, for instance up to about 40×10⁻⁶/° C., it may be desirable to reduce this upper limit of the R(A) range even further, for the best coating properties.

For substrates having a CTE of at least 40×10⁻⁶/° C., generally the broad range of R(A) values mentioned above is again applicable. However, at higher inorganic phase contents, R(A) values at the higher end of this range may result in cracking. Therefore, for coatings having an inorganic phase content of at least 95 weight % of the structural components, an R(A) value in the range 0.5 to 0.95 may be preferred.

For substrates having a CTE of at least 60×10⁻⁶/° C., preferred coating compositions having an inorganic phase content of at least 90 weight % of the structural components have an R(A) value in the range 0.5 to 0.9.

For substrates having a CTE of at least 80×10⁻⁶/° C., preferred coating compositions having an inorganic phase content of at least 90 weight % of the structural components have an R(A) value in the range 0.5 to 0.85.

For substrates having a CTE of at least 100×10⁻⁶/° C., preferred coating compositions having an inorganic phase content of at least 90 weight % of the structural components have an R(A) value in the range 0.5 to 0.8.

It will be appreciated that the above R(A) ranges are applicable to coating compositions having lower inorganic phase contents than those specifically mentioned above.

Specific examples are given below for coating compositions based on:

i) Component A1 being tetraethoxysilane

ii) Component A2 being 3-methacryloxypropyltrimethoxysilane

iii) The polymerisable organic species being aliphatic urethane acrylate monomer, supplied by Akcros Chemicals under product code 260GP25.

iv) The photoinitiator being Irgacure 500, supplied by CIBA Speciality Chemicals.

The preferred boundary coating composition values for deposition onto a metal substrate with a coefficient of thermal expansion of 12×10⁻⁶/° C. are:

a) Inorganic phase content of 99 weight %, R(A)<0.98

b) Inorganic phase content of 95 weight %, R(A)<0.99

The preferred boundary coating composition values for deposition onto a plastic substrate with a coefficient of thermal expansion of 68×10⁻⁶/° C., i.e. polycarbonate, are:

a) Inorganic phase content of 99 weight %, R(A)<0.81

b) Inorganic phase content of 95 weight %, R (A)<0.83

c) Inorganic phase content of 90 weight %, R(A)<0.85

d) Inorganic phase content of 75 weight %, R(A)<0.96

The preferred boundary coating composition values for deposition onto a painted substrate where the paint has a coefficient of thermal expansion of 100×10⁻⁶/° C. are:

a) Inorganic phase content of 99 weight %, R(A)<0.65

b) Inorganic phase content of 95: weight %, R(A)<0.67

c) Inorganic phase content of 90 weight %, R(A)<0.70

d) Inorganic phase content of 75 weight %, R(A)<0.75

Another way of characterising the different coating compositions is in terms of their final properties. Generally, coating compositions having higher R(A) values result in the best hardness and abrasion resistance, for instance R(A) values in the range 0.7 to 0.95 or 0.7.5 to 0.90. Suprisingly, it has also been found that coating compositions having R(A) values in the range 0.4 to 0.8, for instance 0.5 to −0.8, preferably 0.5 to 0.75, and more preferably 0.5 to 0.7, have improved hydrolytic stability. In other words, such coatings can withstand immersion in water for a number of days, or exposure to humidity and heat, without cracking. Generally, for applications requiring hydrolytic stability, the lower the R(A) value the better the coating.

Other useful coating compositions with have R(A) values in the range 0.4 to less than 0.624, for instance in the ranges 0.4 to less than 0.62 or 0.4 to 0.61, for instance about 0.5, or in the ranges 0.63 to 0.909 or 0.63 to 0.95.

In use, a coating composition comprising the inorganic sol mixed with the polymerisable organic species is applied to the surface of a substrate. Polymerisation of the polymerisable organic species may be initiated prior to application to the substrate, or more typically after application to the substrate, but in either case it is important that this polymerisation be initiated prior to completion of polymerisation of the inorganic monomers present in the inorganic sol. The method used to cure the coating will depend upon the nature of the polymerisable organic species and/or component A2 of the inorganic sol. It may be necessary, or desirable, to use a combination of different curing techniques. For instance, curing may be initiated using one technique, and then completed using another. For example, when component A2 is thermally-curable and the polymerisable organic species is UV-curable, curing may be initiated by UV irradiation which, through its IR component, may also progress curing of the inorganic sol. Curing of the inorganic sol may then be taken substantially to completion by another technique, for instance by heat treatment or irradiation with IR light.

The present invention is now further illustrated by way of the following examples.

### EXAMPLES

### Example 1

### Hard Coating For Transparent Plastics

A sol was prepared as follows:

Part A

25.0 g of tetraethoxysilane (TEOS) was placed in a beaker, and an intimate mixture of 22.1 g methanol and 4.32 g distilled water and 0.3 g of hydrochloric acid was added thereto.

Part B

6.0 g of 3-(trimethoxysilyl)propylmethacrylate (MPTMA) was placed in a beaker, and an intimate mixture of 4.4 g methanol, 0.65 g distilled water and 0.2 g hydrochloric acid was added thereto.

The R(A) value of this composition was 0.83 Parts A and B were then stirred, separately, in sealed beaker for approximately 30 minutes, after which they were combined for about 30 minutes, again in a sealed beaker.

The resulting sol was then aged at 50° C. for approximately 24 hours to allow development of the inorganic network. 5.0 g of distilled water was then added approximately 1 hour, the sol was then mixed with 0.60 g of an aliphatic urethane acrylate (sold by Akcros Chemicals under product code 260GP25), and 0.1 g of a mixture of 50% 1-hydroxycyclohexylphenylketone:50% benzophenone as photoinitiator. The resulting solution was mixed thoroughly for at least 1 hour and then stored in a sealed container and kept in a darkened storage cabinet.

When required the solution was deposited as a coating onto polycarbonate, acrylic and polyester substrates, the volatiles were allowed to flash-off at room temperature and the coating was subjected to UV irradiation from a UV lamp to cure the organic component. The coating had an organic phase content of 5 weight % (i.e. the inorganic phase content was 95 weight %).

### Example 2

### Hard Coating with Hydrolytic Stability

A sol was prepared as follows:

Part A

130.0 g of TEOS was placed in a beaker, and an intimate mixture of 115 g methanol and 22.5 g distilled water and 0.3 g of hydrochloric acid was added thereto.

Part B

51.0 g of MPTMA was placed in a beaker, and an intimate mixture of 38 g methanol, 5.5 g distilled water and 0.2 g hydrochloric acid was added thereto.

The R(A) value of this composition was 0.75

Parts A End B were then stirred, separately, in sealed beakers for approximately 30 minutes, after which they were combined for about 30 minutes, again a sealed beaker.

The resulting sol was then aged at 50° C. for approximately 24 hours to allow development of the inorganic network 28 g distilled water was then added to the sol. After stirring in a sealed container for approximately 1 hour, the sol was then mixed with 3.9 g of an aliphatic urethane acrylate (sold by Akcros Chemicals under product code 260GP25), and 0.2 g of a mixture of 50% 1-hydroxycyclohexylphenylketone:50% benzophenone as photoinitiator. The resulting solution was mixed thoroughly for at least 1 hour and then stored in a sealed container and kept in a darkened storage cabinet.

When required the solution was deposited as a coating onto polycarbonate, acrylic and polyester substrates, the volatiles were allowed to flash-off at room temperature and the coating subjected to UV irradiation from a UV lamp to cure the organic component. The coating had an organic phase content of 5 weight % (i.e. the inorganic phase content was 95 weight %).

The resulting coating exhibited enhanced stability against cracking and crazing when immersed in water at 65° C. for up to 5 days, and was able to withstand exposure at 40° C./100% RH for more than 11 days.

### Example 3

### Hard Coating with Hydrolytic Stability

A sol was prepared as follows:

Part A

80.0 g of TEOS was placed in a beaker, and an intimate mixture of 71 g methanol and 14 g distilled water and 0.3 a of hydrochloric acid was added thereto.

Part B

50.0 g of MPTMA was placed in a beaker, and an intimate mixture of 37 g methanol, 5.4 g distilled water and 0.2 g hydrochloric acid was added thereto.

The R(A) value of this composition was 0.66

Parts A and B were then stirred, separately, in sealed beakers for approximately 30 minutes, after which they were combined for about 30 minutes, again a sealed beaker.

The resulting sol was then aged at 50° C. for approximately 24 hours to allow development of the inorganic network. 19.3 g of distilled water was then added to the sol. After stirring in a sealed container for approximately 1 hour, the sol was then mixed with 3.1 g of an aliphatic urethane acrylate (sold by Akcros Chemicals under product code 260GP25), and 0.2 g of a mixture of 50% 1-hydroxycyclohexylphenylketone:50% benzophenone as photoinitiator. The resulting solution was mixed thoroughly for at least 1 hour and then stored in a sealed container and kept in a darkened storage cabinet.

When required the solution was deposited as a coating onto polycarbonate, acrylic and polyester substrates, the volatiles were evaporated off by placing the coated sample into an oven at 80° C. for 5 minutes. The coating was then subjected to UV irradiation from a UV lamp to cure the organic component. The coating had an organic phase content of 5 weight % (i.e. the inorganic phase content was 95 weight %).

The resulting coating exhibited enhanced stability against cracking and crazing when immersed in water at 65° C. for up to 10 days.

### Example 4

### Hard Coating for Aluminium

A sol was prepared as follows:

Part A

57.5 g of TEOS was placed in a beaker, and an intimate mixture of 50.8 g methanol and 9.94 g distilled water and 0.3 g of hydrochloric acid was added thereto.

Part B

11.3 g of MPTMA was placed in a beaker, and an intimate mixture of 8.4 g methanol, 1.23 g distilled water and 0.2 g hydrochloric acid was added thereto.

The R(A) value of this composition was 0.86

Parts A and B were then stirred, separately, in sealed beakers for approximately 30 minutes, after which they were combined for about 30 minutes, again a sealed beaker.

The resulting sol was then aged at 50° C. for approximately 24 hours to allow development of the inorganic network. 9.6 g of distilled water was then added to 120 g of the sol. After stirring in a sealed container for approximately 1 hour, the sol was then mixed with 1.1 g of an aliphatic urethane acrylate (sold by Akcros Chemicals under product code 260GP25), and 0.1 g of a mixture of 50% 1-hydroxycyclohexylphenylketone:50% benzophenone as photoinitiator. The resulting solution was mixed thoroughly for at least 1 hour and then stored in a sealed container and kept in a darkened storage cabinet.

When required the solution was deposited as a coating onto an aluminium substrate, the volatiles were allowed to flash-off at room temperature and the coating subjected to UV irradiation from a UV lamp to cure the organic component. The coating had an organic phase content of 5 weight % (i.e. the inorganic phase content was 95 weight %).

### Example 5

### Hard Coating for Stainless Steel Alloy

A sol was prepared as follows:

Part A

60.0 g of TEOS was placed in a beaker, and an intimate mixture of 53.0 g methanol and 10.37 g distilled water and 0.3 g of nitric acid was added thereto.

Part B

4.5 g of MPTMA was placed in a beaker, and an intimate mixture of 3.3 g methanol, 0.49 g distilled water and 0.2 g nitric acid was added thereto.

The R(A) value of this composition was 0.94

Components A and B were then stirred, separately, in sealed beakers for approximately 30 minutes, after which they were combined for about 30 minutes, again a sealed beaker.

The resulting sol was then aged at 50° C. for approximately 24 hours to allow development of the inorganic network. 9.9 g of distilled water was then added to 120 g of the sol. After stirring in a sealed container for approximately 1 hour, the sol was then mixed with 1.0 g of an aliphatic urethane acrylate (sold by Akcros Chemicals under product code 260GP25), and 0.1 g of a mixture of 50% 1-hydroxycyclohexyl phenylketone:50% benzophenone as photoinitiator. The resulting solution was mixed thoroughly for at least 1 hour and then stored in a sealed container and kept in a darkened storage cabinet.

When required the solution was deposited as a coating onto a n aluminium substrate, the volatiles were allowed to flash-off at room temperature and the coating subjected to UV irradiation from a UV lamp to cure the organic component. The coating had an organic phase content of 5 weight % (i.e. the inorganic content was 95 weight %).

### Example 6

### Hard Coating Containing Alumina

A sol was prepared as follows:

Part A

20.0 g of TEOS was placed in a beaker, and an intimate mixture of 19.4 g of methanol, 1.73 g of distilled water and 0.2 g of hydrochloric acid was added thereto. After one hour of mixing, 2.35 g of aluminium trisecbutoxide (ASB) was added. This solution was then mixed for at least 12 hours and then a further 1.73 g of distilled water was added. The solution was stirred for 1 hour and then a further 0.34 g of distilled water was added.

Part B

10.0 g of MPTMA, was placed in a beaker, and an intimate mixture of 7.4 g of methanol 1.09 g of distilled water and 0.2. g of hydrochloric acid was added thereto. The solution was then stirred in a sealed beaker for approximately 1 hour.

The R(A) value of this composition was 0.72

The ratio of TEOS:ASB was 10.1.

Parts A and B were then combined and stirred in sealed beaker for 30 minutes. The resulting sol was then aged for at least 24 hours in a sealed container to allow the development of the inorganic network. 4.88 g of distilled water was then slowly added to the solution. After mixing for at least 1 hour in a sealed container 0.73 g of UV-curable an aliphatic urethane acrylate sold by Across Chemicals under product code 260GP25, and 0.1 g of a mixture of 50% 1-hydroxycyclohexyl phenylketone:50% benzophenone as photoinitiator. The resulting solution was stored in a sealed container and kept in a darkened storage cabinet.

When required the solution was deposited as a coating onto polycarbonate, acrylic and aluminium substrates, the volatiles were allowed to flash-off at room temperature and the coating subjected to UV irradiation from a UV lamp to cure the organic component. The coating had an organic phase content of 5 weight % (i.e. the inorganic phase content was 95 weight %).

### Example 7

### Hard Coating for Transparent Plastics

A sol was prepared as follows:

Part A

85.0 g of TEOS was placed in a beaker, and an intimate mixture of 75.1 g methanol and 14.69 g distilled water and 0.3 g of hydrochloric acid was added thereto.

Part B

100.0 g of MPTMA was placed in a beaker, and an intimate mixture of 74.1 g methanol, 10.87 g distilled water and 0.2 g hydrochloric acid was added thereto.

The R(A) value of this composition was 0.50

Parts A and B were then stirred, separately, in sealed beakers for approximately 30 minutes, after which they were combined for about 30 minutes, again in a sealed beaker.

The resulting sol was then aged at 50° C. for approximately 24 hours to allow development of the inorganic network. 25.6 g of distilled water was then added to the sol. After stirring in a sealed container for approximately 1 hour, the sol was then mixed with 5.1 g of an aliphatic urethane acrylate (sold by Akcros Chemicals under product code 260GP25), and 0.25 g of a mixture of 50% 1-hydroxycyclohexylphenylketone:50% benzophenone as photoinitiator. The resulting solution was mixed thoroughly for at least 1 hour and then stored in a sealed container and kept in a darkened storage cabinet.

When required the solution was deposited as a coating onto polycarbonate, acrylic and polyester substrates, the volatiles were allowed to flash-off at room temperature and the coating was subjected to irradiation from a UV lamp to cure the organic component. The coating had an organic phase content of 5 weight % (i.e. the inorganic phase content was 95 weight %).

The coating withstood immersion in water at 65° C. for >240 hours, and exposure at 40° C./100% RH for >32 days, without cracking.

### Example 8

### Hard Coating for Transparent Plastics

Example 7 was repeated, except that after curing by UV irradiation, the sample was subjected to a heat treatment of 65 hours at 120° C.

### Example 9

### Hard Coating for Transparent Plastics

The same coating composition as in Example 7 was prepared except that the polymerisation initiator used was 0-0.25 g of benzoyl peroxide (sold under the trade name Luperox A75FP®). The resulting solution was mixed thoroughly for at least 1 hour and then stored in a sealed container and kept in a darkened storage cabinet.

When required the solution was deposited as a coating onto polycarbonate, acrylic and polyester substrates, the volatiles were allowed to flash-off at room temperature and the-coating was then heated to 13° C. for 2 hours to cure the organic component.

### Example 10

### Hard coating with Hydrolytic Stability and UV Protection

A sol was prepared as follows:

Part A

21.0 g of TEOS and 1.27 g of Tinuvin® 384 (an ultraviolet absorber sold by Ciba Speciality Chemicals) were placed in a beaker, and an intimate mixture of 18.5 g methanol and 3.63 g distilled water and 0.3 g of hydrochloric acid was added thereto.

Part B

25.0 g of MPTMA was placed in a beaker, and an intimate mixture of 18.5 g methanol, 2.72 g distilled water and 0.2 g hydrochloric acid was added thereto.

The R(A) value of this composition was 0.50.

Parts A and B were then stirred, separately, in sealed beakers for approximately 30 minutes, after which they were combined for about 30 minutes, again a sealed beaker.

The resulting sol was then aged at 50° C. for approximately 24 hours to allow development of the inorganic network. 6.35 g of distilled water was then added to the sol. After stirring in a sealed container for approximately 1 hour, the sol was then mixed with 1.27 g of an aliphatic urethane acrylate (sold by Akcros Chemicals under product code 260GP25), and 0.05 g of benzoyl peroxide (sold under the trade name Luperox A75FP) as polymerisation initiator. The resulting solution was mixed thoroughly for at least 1 hour. The solution was then stored in a sealed container and kept in a darkened storage cabinet.

When required the solution was deposited as a coating onto a polycarbonate substrate, the volatiles were allowed to flash-off at room temperature and the coating was then heated to 130° C. for 2 hours to cure the organic component. The coating provided enhanced UV protection to the underlying substrate. The coating had an organic phase content of 5 weight % (i.e. the inorganic phase content was 95 weight %).

The resulting coating exhibited enhanced stability against cracking and crazing when immersed in water at 65° C. for up to 5 days.

### Example 11

### Hard Coating for Transparent Plastics

Example 1 was repeated except that 0.60 g of a polyester acrylate (sold by Akcros Chemicals under product code Actilane® 505), was used to instead of the aliphatic urethane acrylate.

When required the solution was deposited as a coating onto polycarbonate, acrylic and polyester substrates, the volatiles were allowed to flash-off at room temperature and the coating was subjected to UV irradiation from a UV lamp to cure the organic component. The coating had an organic phase content of 5 weight % (i.e. the inorganic phase content was 95 weight %).

The abrasion resistance of some of the above coatings is demonstrated by the results reported in the table below, in which ΔH(%) 500 is the increase in haze after 500 Taber cycles using CS10F wheels loaded to 500 g in accordance with ASTM D1003-97 modified to use a different aperture. The silicone hardcoat AS4000 from GE Bayer have a value of 7.7 on this test.

| Example | 1 | 2 | 3 | 7 | 8 |
|---|---|---|---|---|---|
| ΔH% (500) | 1.8 | 7.5 | 12.5 | 12.5 | 2.4 |

1. A coating composition comprising an inorganic phase homogeneously mixed with an organic phase,
the inorganic phase being obtainable by hydrolysis of first and second hydrolysable inorganic monomer precursors, the first hydrolysable inorganic monomer precursors (A1) being different to the second hydrolysable monomer precursors (A2) and having at least two hydrolysable ligands, and the second hydrolysable inorganic monomer precursors having at least one non-hydrolysable ligand,
the organic phase comprising polymerisable organic species,
characterised in that the molar ratio, R(A), of first hydrolysable inorganic monomer precursors total hydrolysable inorganic monomer precursors (A1 & A2) is in the range 0.4 to 0.99.

2. A coating composition according to claim 1, which, when cured, comprises 50 to 99 weight % inorganic phase based upon the total weight of the inorganic and organic phases.

3. A coating composition according to claim 1 or claim 2, which, when cured, comprises at least 90 weight %, and preferably at least 95 weight % inorganic phase, based upon the total weight of the inorganic and organic phases.

4. A coating composition according to any preceding claim, wherein the ratio R(A) is in the range 0.5 to 0.99.

5. A coating composition according to any preceding claim, wherein the molar ratio R(A) is in the range 0.5 to 0.95.

6. A coating composition according to any preceding claim, wherein the ratio R(A) is in the range 0.5 to 0.9.

7. A coating composition according to any preceding claim, wherein the ratio R(A) is in the range 0.5 to 0.85.

8. A coating composition according to any preceding claim, wherein the ratio (RA) is in the range 0.5 to 0.8.

9. A coating composition according to any preceding claim, wherein the first and second hydrolysable monomer precursors comprise inorganic alkoxides of the general formula:
MR¹ₐR²_{b}(OR³)_{c},
wherein M is an inorganic element selected from the group consisting of Si, Ti, Zr, Fe, Cu, Sn, B, Al, Ge, Ce, Ta and W; R¹ and R² are independently selected from hydrocarbon radicals having 1 to 10 carbon atoms; R³ is an hydrogen atom or an hydrocarbon radical having 1 to 10 carbon atoms; and a and b are independently selected from zero and integers, and c is an integer equal to (x-a-b), where x is the valency of the inorganic element M, and in the first hydrolysable inorganic monomer precursors a=b=zero.

10. A coating composition according to claim 9, wherein the first hydrolysable inorganic monomer precursors are selected from tetralkoxysilanes and the second hydrolyable inorganic monomer precursors are selected from 3-methacryloxypropyltrimethoxysilane (MPTMA), 3-glycidoxypropyltriethoxysilane (GPTS) and N-phenyl-3-aminopropyltrimethoxysilane (PAPMS).

11. A coating composition according to claim 10, wherein the first hydrolysable inorganic monomer precursors comprise tetraethoxysilane and the second hydrolysable inorganic monomer precursors comprise NPTMA.

12. A coating composition according to claim 1 or claim or any of claims 4 to 11 as dependent on claim 1 or claim 2, with the proviso that the coating composition is not a coating composition comprising tetraethoxysilane as the first hydrolysable inorganic monomer precursors, 3-methacryloxypropyl-trimethoxysilane (MPTMA) as the second hydrolysable inorganic monomer precursors, and UV-curable aliphatic urethane acrylate monomers, which, when cured, has an amount of the inorganic phase of 25 weight %, 50 weight % or 75 weight % of the weight of the total coating composition, and which has a R(A) of 0.624, 0.625 or 0.62.

13. A coating composition according to any of claims 1 to 11, with the proviso that the ratio R(A) is not 0.624, 0.625 or 0.62.

14. A coating composition according to any of claims 1 to 11, with the proviso that if the composition comprises tetraethoxysilane as the first hydrolysable inorganic monomer precursors, 3-methacryloxypropyltrimethoxysilane (MPTMA) as the second inorganic monomer precursors and UV-curable aliphatic urethane acrylate monomers as the organic polymerisable species, the ratio R(A) is at least 0.63, preferably at least 0.65.

15. A coating composition according to any of claims 1 to 11, wherein the ratio R(A) is at least 0.63, preferably at least 0.65.

16. A coating composition according to claim 1 or any of claims 9 to 11 as dependent on claim 1, wherein R(A) is in the range of 0.4 to less than 0.624, preferably 0.4 to less than 0.62, more preferably 0.4 to 0.61.

17. A coating composition-according to claim 1 or any of claims 9 and 11 as dependent on claim 1, wherein the ratio R(A) is either i) in the range 0.5 to 0.74, or ii) in the range 0.91 to 0.99.

18. A coating composition according to claim 3, wherein the molar ratio R(A) is in the range 0.4 to 0.95, preferably 0.4 to 0.9, more preferably 0.4 to 0.8, and most preferably is at least 0.5.

19. A coating composition according to any preceding claim, wherein the hydrolysable inorganic precursors and the polymerisable organic species, together, constitute at least 85 weight % of the total weight of the coating composition.

20. A coating composition according to any preceding claim, which further comprises a UV absorber other than a polymerisation initiator.

21. A coating composition according to any preceding claim, wherein the inorganic monomer precursors A1 and A2 are hydrolysed separately from one another to form a first sol and a second sol, which are then mixed together to form a mixed sol, and the mixed sol is then mixed with the polymerisable organic species.

22. A process for providing a protective coating on a substrate, the substrate preferably being selected from plastics, metals, ceramic materials, natural materials such as leather and wood, and synthetic substitutes therefor, and pre-coated substrates such as painted and varnished substrates, the process comprising applying to the substrate a coating composition as defined in any preceding claim, and curing said composition.

23. A process according to claim 22, wherein the substrate is selected from polycarbonate and polyacrylic substrates.

24. A coated substrate obtainable by the process defined in any of claims 21 to 23.
